(19) United States
(12) Patent Application Publication
(10) Pub. No.: US 2025/0232669 A1
(43) Pub. Date: Jul. 17, 2025

(54) Driving aid system to improve safety, save fuel, and reduce emissions

(71) Applicant: Tianxin Wang, Walnut Creek, CA (US)

(72) Inventors: Leonardo Wang, Walnut Creek, CA (US); Tianxin Wang, Walnut Creek, CA (US)

(21) Appl. No.: 19/005,771

(22) Filed: Dec. 30, 2024

Related U.S. Application Data
(60) Provisional application No. 63/682,326, filed on Aug. 12, 2024.
(60) Provisional application No. 63/620,779, filed on Jan. 13, 2024.
(60) Provisional application No. 63/618,354, filed on Jan. 7, 2024.

(51) Int. Cl. G08G 1/096; G08G 1/09

(52) U.S. Cl. CPC G08G 1/096; G08G 1/093

(57) ABSTRACT

The current application discloses an intelligent driving aid system comprising a roadside sign, and method to improve energy efficiency and safety by informing drivers of whether they can reach the green light ahead in time. The roadside sign is placed away from the traffic lights and communicates with the traffic lights ahead wirelessly.

### CROSS-REFERENCE TO RELATED APPLICATIONS

This application claims benefit of and priority to U.S. Provisional Patent Application Ser. Nos. 63/618,354 filed on Jan. 7, 2024; 63/620,779 filed on Jan. 13, 2024 and 63/682,326 filed on Aug. 12, 2024; which are incorporated herein by reference in its entirety for all purposes. The entire disclosure of the prior applications are considered to be part of the disclosure of the instant application and are hereby incorporated by reference.

### BACKGROUND

In 2022, 34 billion barrels of oil were consumed across the world. In the United States, 67% of oil consumption was by transportation, primarily motor vehicles. Transportation makes up roughly one third of carbon emissions globally, and is the largest source of carbon emissions in industrialized countries. Gasoline consumption per miles traveled is much higher in cities than on highways due to frequent acceleration and deceleration mostly due to traffic lights. For example, mileage of 2023 Ford Mustang EcoBoost is 31 MPG on highway and 21 MPG in city. Annually in the United States, 260 thousand crashes occur as a consequence of drivers running red lights. In these accidents, 176 thousand are injured annually.

### SUMMARY OF THE INVENTIONS

The current invention discloses intelligent driving aid sign/display system and method that can help drivers save fuel, reduce emissions, provide a less stressful driving experience, and make for safer driving.

The method and system disclosed in current invention is to improve driver experience, energy efficiency, and safety while driving, by creating an intelligent driving aid system for drivers that informs drivers of whether they can reach the next green light in time or not so they can adjust their driving patterns (e.g. speed). It has the potential to reduce fuel and energy consumption by up to 1 billion barrels of oil (roughly 75 billion USD assuming a price of 75 USD per barrel) per year (eliminating 500 million tons of CO2 emission annually). It also has the potential to reduce red light violation crashes by 130 thousand per year, and resulting injuries by 80 thousand in the United States and much more globally.

### BRIEF DESCRIPTION OF THE DRAWINGS

FIG. 1 shows an exemplary scenario of the road side system informing the car that it cannot reach the greenlight in time.

FIG. 2 shows an exemplary scenario of the road side system displaying no signal when the car can reach the greenlight in time.

FIG. 3 shows another exemplary schemes of the roadside system informing the driver if the car can reach the greenlight in time or not.

FIG. 4 shows examples of road side sign having LED display and printed instructions.

FIG. 5 shows examples of the system and their communication schemes.

FIG. 6 shows an example of roadside system sending prediction result to the car in wireless signal.

FIG. 7 shows an example of roadside system sending signal to dashboard device to inform driver in voice that the car cannot pass traffic lights ahead without stopping.

FIG. 8 shows an example of roadside system sending signal to dashboard device to inform driver in voice that the car can pass the traffic lights ahead without stopping and the minimum speed required.

FIG. 9 shows examples of roadside system using beamforming.

FIG. 10 shows examples of roadside system using positioning sign.

FIG. 11 shows examples of roadside system showing the status of next traffic lights ahead and the distance to the next traffic lights.

FIG. 12 shows examples of intelligent stop sign.

FIG. 13 shows another example of intelligent stop sign.

### DETAILED DESCRIPTION

The system of the current invention is an intelligent driving prediction system that informs drivers of whether they can reach the next green light in time or not, and thus whether they should further accelerate or have the vehicle glide and rely primarily or solely on momentum, in order to increase fuel efficiency and reduce the risk of red light traffic violations. If the prediction is the traffic light will not be green when they reach the intersection, the driver (including vehicle controlling system if autopilot is on) should not keep on press the accelerator (e.g. gas pedal) which will consume unnecessary energy (e.g. fuel) resulting in high speed when they reach the traffic light which make they have to apply hard brake to stop, instead they should let the vehicle glide and rely primarily or solely on momentum so the engine will consume minimal fuel (or electricity if it is an electrical car).

The method and system of the current invention will also reduce brake/tire/engine wear and extend their life.

In some embodiments the system comprise a road sign or road display installed at the roadside or on top of the road. The road sign or road display can produce visual signal to the driver passing by to inform the driver if they can reach the next traffic light when the light is green light or not. The visual signal can be light such as colored lamp (e.g. red light similar to traffic light) including flashing light, or a display panel (e.g. LED or LCD display) that can display image or words such as “red light soon”, “cannot reach green light in time” etc. on demand, or other words/image that can inform the driver; or combination of the above. In some embodiments it is installed about 0.05 to 0.5 miles away to the upcoming traffic light. In some embodiments it is installed about 0.1 to 0.5 miles away to the upcoming traffic light. In some embodiments it is installed about 0.1 to 0.3 miles away to the upcoming traffic light. In some embodiments it is installed no more than one green light distance away to the upcoming traffic light, wherein one green light distance is calculated using speed limit multiplied by time of the full green light duration time of one green/red light cycle.

The prediction is based on the distance between the sign/display and the intersection, the speed (which can be a preset speed such as speed limit or the speed of the vehicle), which will generate the time to reach (TOR, time required to reach the interception, equals to the distance divided by the speed) and traffic light status after TOR. If the traffic light status right after TOR is red light, the prediction is the car will not be able to pass the intersection while green light is on (the car will meet red light) and the system will inform the driver accordingly with a signal. When driver and/or a device in the car receives (e.g. see or hear) the signal, a decision can be made accordingly to save energy and prepare to stop.

In some embodiments, the Time of green and/or Time to green can be used to aid the prediction. Time of green (TOG) is how much green light time left before the controlling traffic light becomes red when the car passes the roadside sign. Time to green (TTG) is the time left for red light to become green light when the car passes the roadside sign. When the current light is green and TOG is less than TOR, the prediction is the car cannot pass in time without stopping. When the current light is red and TOR is less than TTG, the prediction is the car cannot passes the intersection without stopping or reducing the speed. In some embodiments, the TOG further includes time of yellow light, therefore the TOG will be the same as TTR (time left until red light).

In some embodiments, the preset speed is the allowed speed limit of that road. In some embodiments, the speed is a little higher than the speed limit (e.g. 5 miles higher) as sometimes slightly higher driving speed is allowed.

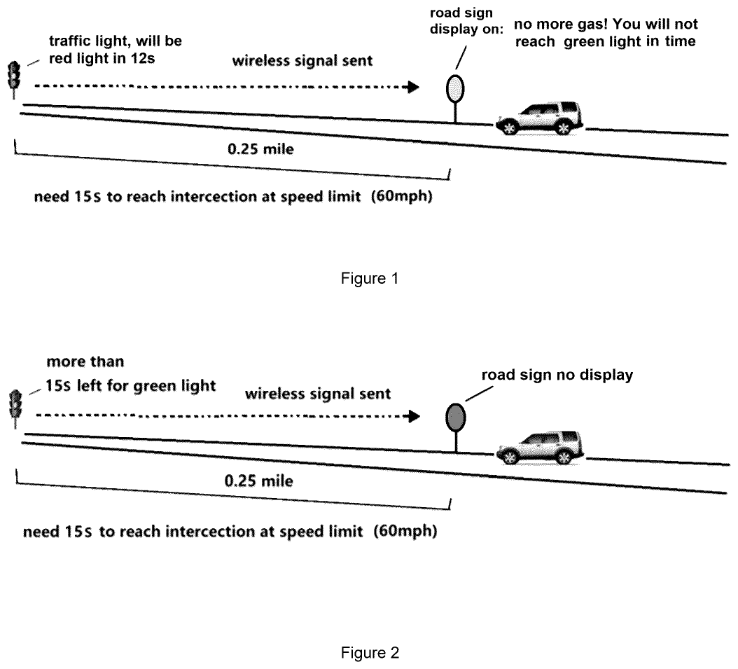

FIG. 1 shows an exemplary scenario of the roadside system informing the car that it cannot reach the greenlight in time. In this scenario, the speed limit is 60 mph and the road side sign/display is placed 0.25 miles from the upcoming traffic light. Thus, it should take 15 seconds for a car to reach the intersection driving the speed limit or more than 15s if the speed is lower than speed limit. The traffic light has a wireless signal emitter/transmitter that sends wireless data signal to the roadside sign on how much time left before the traffic light turns to red light. If there are less than 15 seconds until the light turns red, the sign/display will turn on (e.g. flashing light on or displaying alarm message such as “red light soon, prepare to stop”), indicating that cars driving at the speed limit or lower cannot pass the intersection without stopping at the traffic light and should prepare to stop and not further accelerate unless the current speed is too low for the traffic.

FIG. 2 shows an exemplary scenario of the roadside system displaying no signal when the car can reach the greenlight in time. In this scenario, there are more than 15 seconds until the light turns red, the sign/display will remain off and display nothing or display advertisement to generate income or provide other information (e.g. environmental temperature/weather etc.). The driver will know that she/he can pass the greenlight without stopping if the car is at sufficient speed (e.g. at speed limit). Alternatively in some embodiments, the roadside sign can display the minimal speed the car need to drive in order to catch the green light (or yellow light in some scenarios) if the car can pass the traffic light at safe speed without stopping. The minimal speed can be calculated as distance of road sign to traffic light/green time left or distance of road sign to traffic light/time left until red light. For scenario in FIG. 2, if time to green is 30s, the roadside sign can display: “maintain speed at 30 mph or higher” as 0.25 miles/30 s=30 mph. The displayed speed will increase when time left to green decreases.

If the sign/display is on, it means that the car should avoid to spend more energy accelerating to reach the intersection, thus reducing the amount of energy and fuel potentially wasted trying to pass an intersection that cannot be reached in time and require hard brake to stop. This will also serve to make driving more predictable, as people will not have to worry about whether they should try to make the vehicle past the intersection or not when they see a green light afar that may or may not soon turn red, therefore reduce traffic light panic.

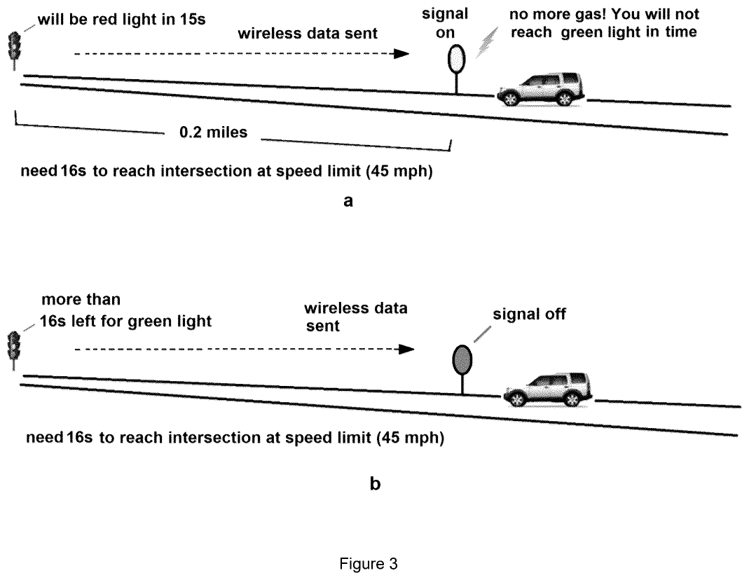

Another example is shown in FIG. 3. The roadside sign is placed 0.2 miles away from the intersection. Driving at speed limit 45 mph will require 16s to reach it from the sign. If the traffic light is green and it will turn into red in 15 s, the signal of the road sign will be turned on, inform the driver passing the sign that he/she will need to prepare to stop at the intersection 0.2 miles ahead as shown in FIG. 3a. If the green light will last for more than 16 s as shown in FIG. 3b, the road sign will not provide any signal, the driver will know he/she may be able to pass the green light in time.

In some embodiments, if the prediction is the driver may catch the green light and may pass without stop, instead of display nothing or displaying none traffic related content, it can display a signal informing the driver they may not need to stop (e.g. “you may reach the green light”), preferably with the speed required to catch the green light safely, e.g. the speed will be the distance/TOG or the distance/(TOG+yellow light duration). If the minimal speed required is 30 mph, the display can be “minimal 30 mph to meet green light”. If the current light is red light, in order to catch the green light, then the driving speed need to be slower than distance/remaining red light time, or prepare to stop and wait at red light, the system can signal the driver accordingly.

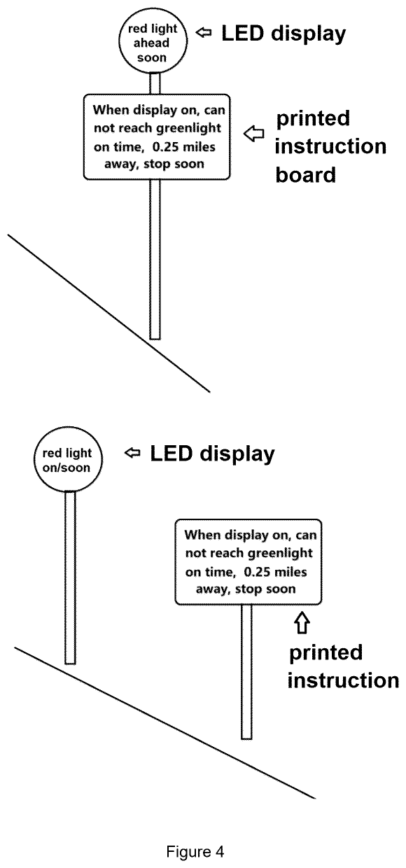

Because the size/content of the sign/display may be limited and people may not understand how to read/use it, initial training to drivers may be required, e.g. incorporate it in the DMV manual, driving school and test preparation material etc. Another solution is to add additional sign having written instructions to explain the purpose and how to use/read the sign/display, which can be either incorporated within the original sign/display or placed next to it. The additional sign can be just a simple road sign having printed/painted explanation/instruction without any electronic/moving part. For example as shown in FIG. 4, the additional sign is a simple plate painted with instruction of how to read the LED display for prediction. It can be integrated as one sign (top figure) or placed next to each other (bottom figure).

In some embodiments, the system comprises a wireless receiver that receives signals/data (e.g. time left before traffic light changes, TOG, TTG) from traffic lights ahead, or from a central control station (e.g. road agency) if they are controlled centrally or collected to send to a central data base. The wireless receiver module is incorporated within the road side sign/display unit. Alternatively, the signal from traffic lights ahead or central control station use wire for data transmission. If signal is sent from traffic lights, an adaptor/unit that can monitor the status and collect data from the traffic lights will be installed within or attached to the traffic lights unit. It will also have communication module (circuitry) that sends data signal to the sign/display wirelessly or using wire between the traffic lights and sign/display unit for communication. Sign/display can receive power from solar panels installed or nearby power lines. A rechargeable battery can be incorporated within the roadside sign/display system which can be charged by the solar panel and provide power to the system when there is not enough sun light. The wireless communication can unitize existing wireless network such as mobile network/internet to transmit data/signal, or it can use direct wireless signal transmission, e.g. the adaptor/unit attached to/incorporated within the traffic lights communicates with the wireless receiver unit of the sign/display directly using electromagnetic wave such as radio frequency signal without using cellphone network/internet.

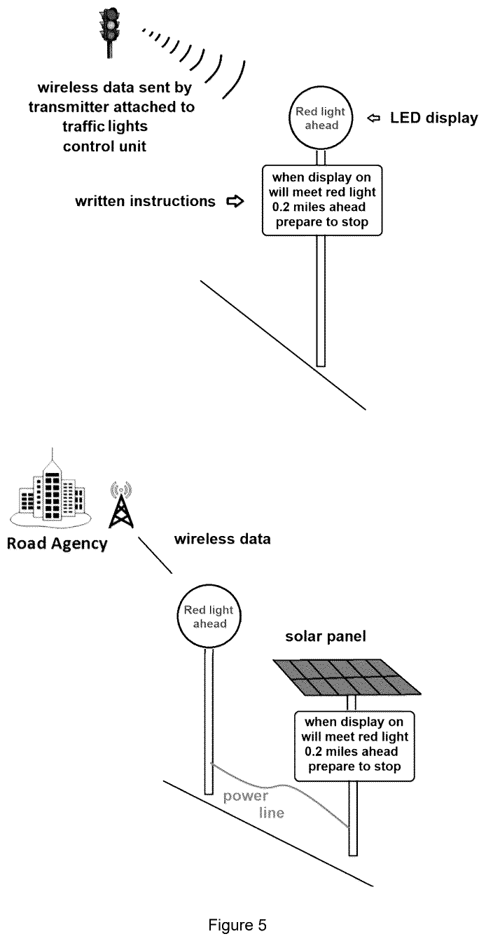

Examples of the system and their communication schemes are shown in FIG. 5. FIG. 5 top shows an example of the system comprising a roadside sign with a LED display showing “Red light ahead” in red, printed instruction board below the LED display, and a traffic light ahead that sends wireless data to the roadside sign. FIG. 5 bottom shows an example of the system comprising a roadside sign with a LED display showing “Red light ahead” in red, a separate printed instruction board having a solar panel that can provide power to the roadside sign. A traffic control or monitoring center such as road agency sends wireless data of the status of the traffic lights ahead to the roadside sign.

Another method for the roadside sign/display unit to determine the current and predicted traffic lights status is to use a camera, which can be mounted on the sign/display unit and provide the status data to the control unit of the sign/display, or mounted on the traffic lights or somewhere between the sign/display and intersection, and transmit the status data to the sign/display using wired or wireless signal. The camera faces the traffic lights and monitors its status (light color and duration). The current traffic light status (e.g. green or red) and when it stated/how long it stayed and also the pattern of traffic lights in the past cycles are captured by the camera. The prediction (e.g. TOG, TTG, time left until red) can be made based on the data collected by the camera. For example, the TTG/TOG can be determined based on the current light status and how long it has been on together with known pattern/cycle time of each color of the traffic light. The pattern/duration time of each color (e.g. full duration time of green light, yellow light and red light in a cycle) can be a preset value entered or based on the results observed by camera during the past cycles (e.g. the duration time/how long each light lasted in the last cycle or average of several past cycles monitored recently, for example, average of 3 past cycles). For example, if the observed average green light plus yellow light duration time in the past 3 cycles is 20s and the green light has been on for 15s already as seen by the camera, the time left before changing to red is 5s. Using this approach, no adaptor attached to traffic lights as described previously is required.

Some traffic lights have light for turning (left turn and sometimes right turn as well). Similarly, the system can also be used to predict if the car can catch left turn or right turn green light as well. It can be implemented by using a separate dedicated left turn or right turn sign/display. For example, a dedicated left turn sign/display can be placed in the center of the road and marked with “for left turn”. Alternatively, they (going straight and turning left/right) can be integrated in one sign/display and the prediction for each condition takes turn to display (alternating display).

The current inventions disclose a driving aid system for improving safety and energy efficiency of a vehicle, said system comprising a traffic lights having a wireless signal transmitter that transmits its traffic light status data; and a roadside sign having a wireless signal receiver, wherein the roadside sign is placed away from the traffic lights, receives traffic light status data from the traffic lights ahead and informs the vehicle passing said roadside sign if the vehicle can pass the traffic lights without stopping. The traffic light status data includes the time left before the traffic lights turns to red light. The roadside sign is at least 0.1 miles away from the traffic lights. The roadside sign can have a LED display and can be solar powered.

The current inventions disclose a method for improving safety and energy efficiency of a vehicle, the method comprising a traffic lights transmits its traffic light status data to a roadside sign placed away from the traffic lights; the roadside sign receives the traffic light status data from the traffic lights ahead to compare the time left before the traffic lights becomes red and the minimum time required to reach the traffic lights from the roadside sign at safe speed; and the roadside sign informs the vehicle passing it that the vehicle needs to prepare to stop at the traffic lights ahead if the time left is less than the minimum time required. The traffic lights has a wireless signal transmitter to transmit its traffic light status data. The roadside sign has a wireless signal receiver to receive the traffic light status data. The roadside sign uses LED display to inform the vehicle.

In some places, there are traffic lights with timers indicating the amount of time left, but these will be difficult to see until sufficiently close and need to be in unobstructed view, therefore limiting the amount of energy that can be saved, and also they require drivers to make calculations in their head given the time, which may not be trivial. Electrical cars can recover ˜60% of energy if regenerative braking is applied, but 40% of energy is still lost either way, however this can be saved with the system in the current invention.

In some embodiments, models and algorithms that can provide numerical outputs that maximize fuel/energy conservation and improve safety, as well as providing an optimal driving experience, can be developed and incorporated into the system.

According to the estimates, drivers will be able to save ˜3-5% more fuel while driving, which globally amounts to 1 billion barrels of oil, resulting in 75 billion USD of fuel cost being saved.

Using the same estimate (˜3-5%), the amount of fuel saved worldwide will result in a 500 million ton reduction in CO2 emissions annually, equivalent to ˜10% of United States greenhouse gas emissions annually.

If the system can reduce the number of red light violation by an estimated 50%, in the United States, 130 thousand crashes and 80 thousand resulting injuries can be avoided every year, or roughly 650 thousand crashes and 400 thousand injuries worldwide.

In some embodiments, further improved systems that can measure the speed of the vehicle in order to give more personalized guidance are used. This can come in the form of either a standalone device placed in the car (e.g. a dash mounted box) or a cellphone app to provide more accurate information and greater efficiency and safety, which can be even further integrated into the vehicle by partnering with car manufacturers during vehicle design and manufacturing.

The speed of the car can be measured using a speed sensor (such as a GPS unit) in the standalone device, or provided to the standalone device by a cell phone in the car having GPS using wired (e.g. a data cable) or wireless signal (e.g. blue tooth), or by the car itself using wired (e.g. a data cable) or wireless signal (e.g. blue tooth). Another option to determine the speed of the car is that the roadside sign/display described above can emit ultrasound or electromagnetic waves (e.g. radio signal or laser signal) to the coming car and the standalone device has a receiver, the speed of the car can be calculated based on the Doppler effect, similar to the mechanism of the speed radar except the ultrasound/electromagnetic waves transmitter and receiver are placed separately instead of all in one device as radar speed gun.

The standalone device will also receive the status data of the traffic lights ahead (e.g. when it will be red light or turn green) with wireless signal, either from the roadside sign/display system (a wireless transmitter need to be integrated within) or the wireless transmitter of the next traffic light. It can also be from the central control station/traffic status data center (e.g. road agency) using mobile communication network (e.g. cell phone network). The roadside sign/display system informs the car of the distance between the sign/display and next traffic light via wireless signal, when the vehicle pass it, the standalone device will inform the driver (in display or voice) if the car will meet red light based on the traffic light status, distance and current speed. It can also inform the driver the minimal speed to meet green light if possible and distance to traffic light ahead.

Alternatively the distance to the next traffic light ahead can be obtained anytime (not just when passing the roadside sign/display) using GPS unit in the standalone device or obtained from the cellphone or car. Therefore the upcoming traffic light prediction and driving aid can be provided to the driver anytime instead of only for the timepoint when passing the sign/display.

The function of the standalone device can also be implemented using a software approach, e.g. an cellphone app or a software program of the car. Therefore the current invention also disclose a cellphone app or a software of the car, which has modules to obtain the speed of the car, the status of the next traffic lights ahead and the distance of car to the traffic lights ahead, and performs calculation to predict if the car will reach the red light and has to glide/stop, or can pass the green light or yellow light without stopping at the intersection, and inform the driver accordingly and recommend the optimal driving pattern (e.g. speed, accelerating or not, applying brake) to improve safety and energy efficiency, similar to the systems described previously. It can further use the map to provide driving support. The app/car software and its functions can also be integrated into the navigation app such as google map, apple maps, Waze Navigation & Live Traffic, Voice GPS & Driving Directions from Delta Raza Studio, baidu maps, amap (GaoDe map) and etc. The speed, coordinate (location) of the car and its distance to the next traffic lights can be obtained using GPS and map (map can be stored locally or stored in the cloud and being transmitted to app/software), and/or from the road side sign/display system similar to those described in the standalone box using an adaptor or device in the car that can communicate with the road side sign/display if the cellphone or car cannot communicate with the road side sign/display system directly. Alternatively, the cellphone or car can receive wireless data from roadside sign/display in wireless signal such as radio signal. The adaptor or device receives information from road side sign/display system and send it to the app/software using data cable or wireless transmission (e.g. blue tooth, wifi, radio signal).

The status of the traffic light ahead can be delivered to the app/software using mobile network/internet from control center/data center if traffic lights are controlled centrally and/or their status can be uploaded to mobile network/internet by the control center or its data center, or from a cloud database (an online data center) hosting the real-time data uploaded by other app/car software and/or control center. In some embodiments the data of traffic lights status can be transmitted from the traffic lights or from the road side sign/display system directly to an adaptor or device in the car that can communicate with the road side sign/display if the cellphone or car cannot communicate with the road side sign/display system directly, especially if there is no control center and/or no data available from control center/cloud database. The adaptor or device in the car or cell phone receives next traffic light status information from road side sign/display system and send it to the app/software using data cable or wireless transmission (e.g. blue tooth, wifi, radio signal). Optionally the data of next traffic light (e.g. its status, timestamp, location and ID) received can be uploaded to a cloud database using mobile network by the app/car software. This will allow other app/car software be able to receive their next traffic light status without the need of using additional adaptor/device.

In some embodiments, when the car passes a traffic lights, the traffic lights can transmit the traffic light status data of the next traffic lights ahead or the traffic light status data of nearby traffic lights wirelessly to the car or dashboard device or cellphone so the car/dashboard device/cellphone app can calculate accordingly to provide recommendation/guidance to the driver on the driving speed similarly. In these scenarios, the function of roadside system is performed by the traffic lights instead. The traffic lights will need to be able to communicate with the next traffic lights ahead or nearby traffic lights to obtain their status in order to pass the information to the car/dashboard device/cellphone app, which can be done by means incorporated within the traffic lights using wired communication or wireless communication.

Alternatively in some embodiments, the speed of the car is monitored by the roadside sign/display. The sign/display will have a speed monitoring component similar to those used by the speed gun or speed patrol trailer that can monitor the speed of the car coming close to it. Then it will calculate if the coming car will be able to meet the green light or red light at the car's current speed and inform the car. The sign/display can display the prediction using its display or send the result/data to the car/driver using wireless signal (e.g. radio signal, IR or laser). In some embodiments, the wireless signal is beam focused (e.g. using beam foaming technology) to the upcoming car so that car will get its personalized signal/data based on its current speed and other cars behind it or in front of it will not receive the this signal/data that may potentially be inaccurate. Using this approach, the device/app may not need to have its own speed detection mechanism. The device can be a simple wireless signal receiver (e.g. a radio) receiving the data/result from the sign/display and inform the driver accordingly with either visual display or sound/voice.

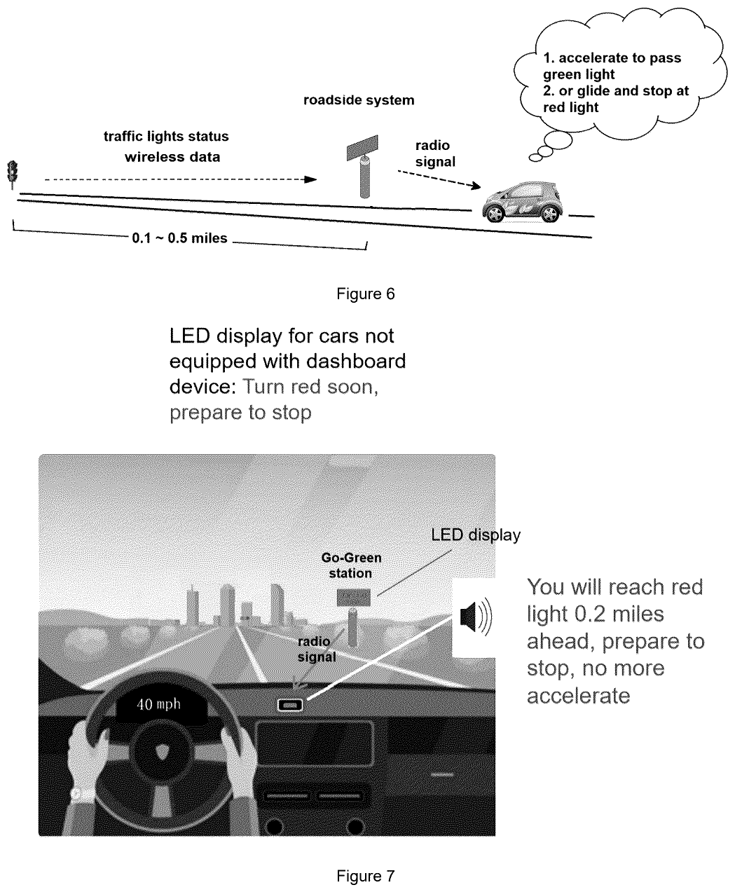

In some embodiments, the intelligent roadside driving prediction system is placed far away from intersection, receives traffic light status data and calculates using its distance to the traffic light, safe speed and time left for green/red lights; informs drivers if they will reach red light or be able to pass green light/yellow light safely. It predicts the status of upcoming traffic lights and informs drivers from a distance of whether they can reach the next green light, advising drivers on whether they should continue accelerate; or, glide to the intersection, preparing to stop. These in-advance warnings and instructions thus increase fuel efficiency and reduce the risk of red light accidents. The intelligent roadside driving prediction system is essentially a roadside sign/display system except it sends wireless signal to the car/dash mount device/driver to provide prediction/driving aid and the built in visible sign/display can be optional. Driver will decide accordingly continue to accelerate to pass green light/yellow light or glide and stop at red light, save fuel and reduce risk of red light violation. An example is shown in FIG. 6, the roadside system is powered by solar panel and sends driving recommendation to the car in wireless signal. A rechargeable battery can be incorporated within the roadside system which can be charged by the solar panel and provide power to the system when there is not enough sun light.

In some embodiments, the system is placed away from the intersection (e.g. >0.1 miles or >0.12 miles) that the car needs at least 10s to reach the intersection at safe speed/speed limit. The further the system is away from the next traffic light ahead, the more fuel saving/energy saving can be achieved.

The roadside station receives wireless data regarding traffic lights' status from transmitters attached to traffic lights ahead or from wireless cameras monitoring them, or from road agencies/data center if the traffic lights are centrally controlled/monitored. If the time left before the next red light starts is less than the minimum time required to reach the intersection from the roadside station (also called Go-Green station) while driving at the speed limit, the station will send its prediction via radio signal beams to the dashboard device to inform the driver using audio to prepare to stop to avoid red light violation and not further accelerate, which also saves fuel. The roadside station can also have an LED display, to provide predictions and instructions to cars not equipped with the dashboard device.

In some examples, the road side system (Go-Green station) receives data from a wireless transmitter attached to traffic lights ahead or a camera system (if traffic light not centrally controlled), or from the local road agency (if traffic lights are centrally controlled or real time traffic lights status center is available). If Time to red light< (Distance of station to traffic light/speed limit), the station sends radio signal to a dashboard device with speaker in the car to inform driver: prepare to stop to avoid red light violation and do not further accelerate to save fuel. An example is shown in FIG. 7. The roadside Go-Green station sends beamed radio signal to the car passing it, the dashboard box receives the signal and inform the driver in voice using its speaker: “you will reach red light 0.2 miles ahead, prepare to stop, no more accelerate”.

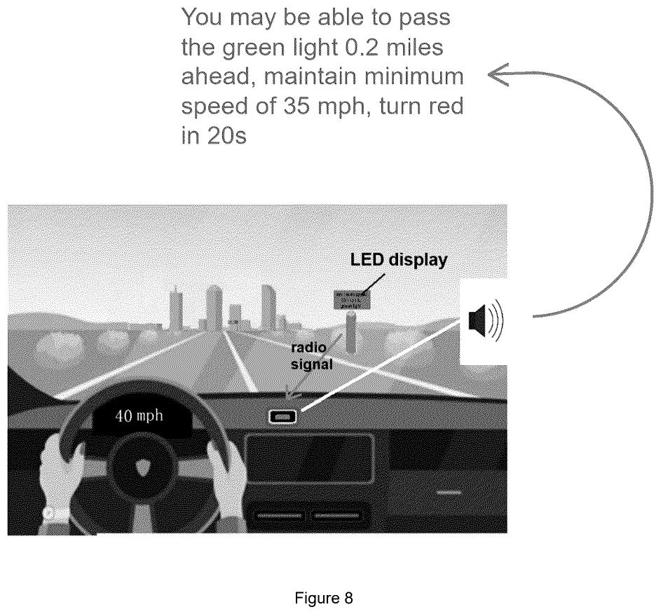

If Time of green light remaining>(Distance of station to traffic light/speed limit), Go-Green station calculates the minimum speed required for safe passing and sends radio signals to the dashboard device regarding the prediction result. Radio signal uses beam forming, signal ID/time stamp to ensure only the dashboard device/car passing the station accepts the transmitted data and acts accordingly. An example is shown in FIG. 8. The roadside Go-Green station sends beamed radio signal to the car passing it, the dashboard box receives the signal and inform the driver in voice using its speaker: “you may be able to pass the green light 0.2 miles ahead, maintain minimum speed of 35 mph, turn red in 20 s.” The minimum speed is calculated from Distance station to traffic light/Time of green light remaining. Optionally the roadside station can measure the speed of the car passing it and inform the car if the speed is below the minimum speed required so the driver should accelerate if he/she want to pass in time; the roadside station can also inform the driver how long the car will reach the traffic light under its current speed. The dashboard device can further have a GPS that can measure the car's speed. Once the dashboard device or cellphone or car app receives the Time of green light remaining and Distance of station to traffic light when the car passes the station, the dashboard device or cellphone or car app can calculate the minimum speed required and inform the driver, it will also inform the driver if the speed need to be adjusted based on the car's current speed and keep on updating the recommendation of speed, time to reach the green light based on current speed and time left for green light when the car approaches the traffic light.

If no issued speed limit from agency available for the road, the roadside station can calculate the minimum speed required (Distance of station to traffic light/Time of green light remaining) to catch the green light and sends radio signals to the dashboard device regarding the data and or the calculation result when the car passes the station. It can also send the Distance of station to traffic light and Time of green light remaining to the device. The dashboard device can have a GPS that can measure the car's speed. Once the dashboard device receives the Time of green light remaining and Distance of station to traffic light when the car passes the station, the dashboard device can calculate the minimum speed required and inform the driver, it will also inform the driver if the speed need to be adjusted based on the car's current speed and keep on updating the recommendation of speed, time to reach the green light based on current speed and time left for green light when the car approaches the traffic light.

In the descriptions above, Time of green light remaining is used. In some embodiments, Time of green light+yellow light remaining can be used instead, because driver can still pass under yellow light. In some embodiments, 80% or 85% or 90% or 95% of Time of green light remaining instead of 100% is used for calculation, to provide higher safety margin.

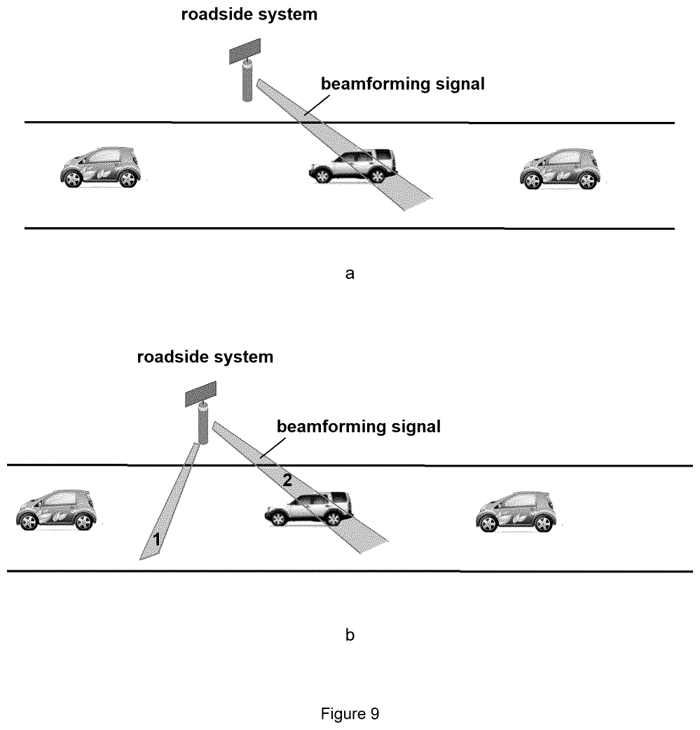

To ensure only the dashboard device in the car passing the station accepts the transmitted data and acts accordingly, beamforming can be used to transmit the signal/data. Beamforming is a signal processing technique used in sensor arrays for directional signal transmission or reception. This is achieved by combining elements in an antenna array in such a way that signals at particular angles experience constructive interference while others experience destructive interference. Beamforming can be used at both the transmitting and receiving ends in order to achieve spatial selectivity. As shown in example in FIG. 9, the roadside system uses beamforming signal to transmit data to the car passing the beam, not the cars already passed the roadside or behind the beam. To ensure only the car approaching the roadside system accept the data, Doppler effect can be used so the cars driving at the opposite direction yet still passing the beam will not accept the data. The Doppler effect can be based on the beam or a separate ultrasound/laser/electromagnetic signal emitted by the roadside system. If more than one beams are used concurrently or sequentially, each beam can have its own ID and time stamp, which can be used by the car to improve selectivity and sensitivity. For example as shown in FIG. 9b, the roadside system emit two beams 1 and 2, only the car pass 2 first and then 1 will accept the data. In some embodiments, the beam is used as a timer and data including traffic status are transmitted in a non-beamforming signal continually in real-time. Only when the car passes the beam, the device will accept the data of that timepoint.

The current invention also discloses a low cost method and system for similar purpose to inform driver if they can reach the green light in time. The method and system is to modify the current traffic lights or add additional indicating display/light to the current traffic lights (either on the same pole or close to it at the intersection) and use a positioning sign optionally without the need of signal transmitter/receiver. A special signal of whether the car can pass the traffic lights without stopping is given by the traffic lights itself or by the additional indicating display/light added to the existing traffic lights or installed at the intersection. When a car reaches the positioning sign and the driver sees the special signal, it means the car will not be able to pass the traffic lights driving at the speed limit or lower without stopping, the car should prepare to stop and possibly reply mostly on gliding without further acceleration to save energy. The special signal can be a unique traffic light pattern approved by the road agency and known by the driver, e.g. a flashing green light, a combination of green light and yellow light, a flashing yellow light and etc., or a different color light (e.g. blue, purple or mixed color such as half area green half area yellow in the lamp). The positioning sign can be a simple static sign having painted content only or can have a dynamic signal such as a flashing light or their combination.

When the time left of green light or the time left before the light becomes red is equal or less than the time of distance between positioning sign and traffic light divided by the speed limit, the special signal will start, e.g. green light start to flash. The system of this invention comprises a roadside positioning sign and a traffic light system, wherein the traffic light will display a special signal to inform driver when the time left of green light or the time left before the light becomes red is equal or less than the time of distance between positioning sign and traffic light divided by the speed limit. In some embodiments, the positioning sign can be placed 0.03˜0.3 miles away from the traffic light and the location of the sign need to allow the driver clearly sees the traffic light when the car passes the sign.

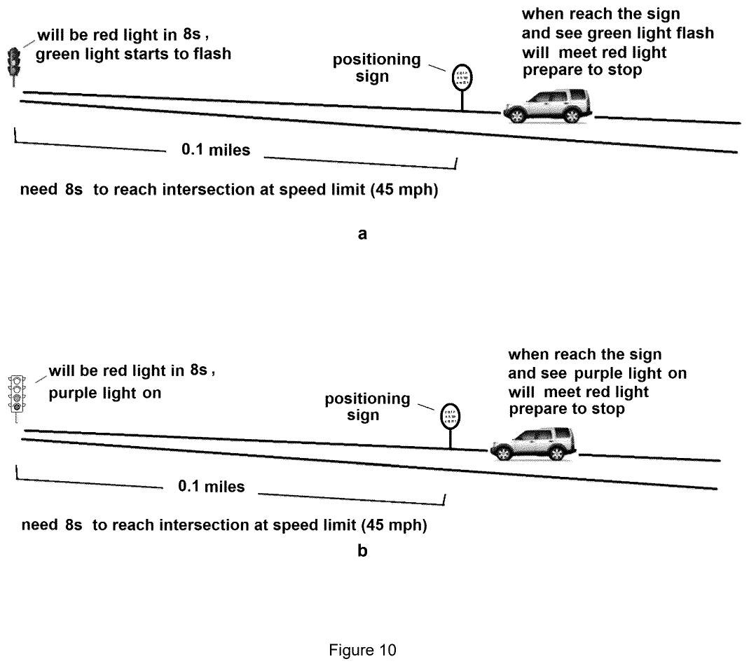

An examples is shown in FIG. 10a. The positioning sign is placed 0.1 miles away from the intersection. A car driving at 45 mph speed limit will need 8s to reach the traffic lights. When there is no more than 8s left before the traffic light becomes red, the green light that currently on will flash (or other signal pattern such as both green light and yellow light on). If a driver arrives at the positioning sign and see the unique signal is on, the car will not be able to pass the traffic light in time without stopping and driver need to act accordingly. The positioning sign can be printed with “red light soon if you see flashing green light” or “red light soon if you see both green and yellow light” depending on the unique signal pattern adopted. The positioning sign does not need to communicate with traffic lights or central controller, and the current traffic lights can be modified easily using software programming, therefore the cost of the system can be reduced significantly.

FIG. 10b shows another example using an additional light (purple) added to the current traffic lights system instead of using new pattern of green/yellow/red. The unique signal is purple light on. Alternatively the additional light or display can be installed on a separate pole instead, which will require communication (and related hardware) with the nearby main traffic light control unit with wire or wirelessly.

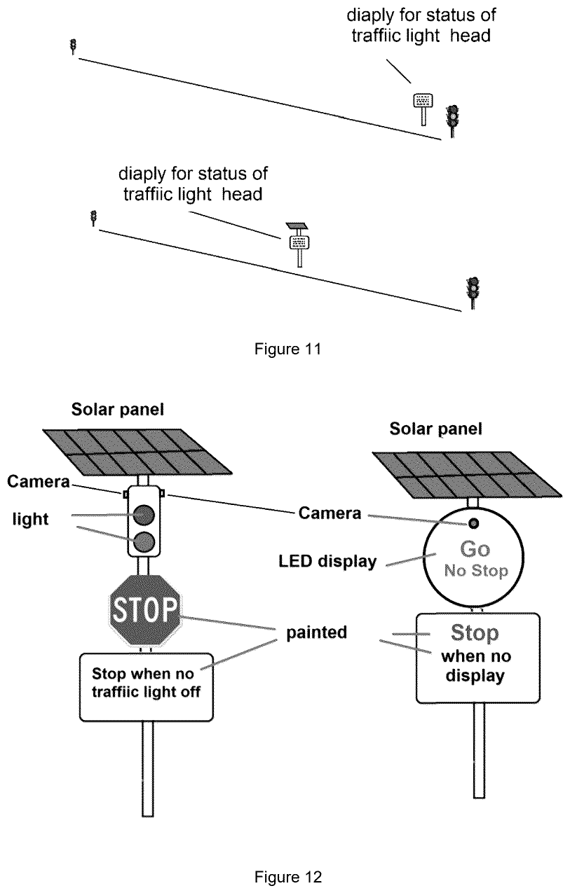

The current invention also discloses a method and system to help driving by placing an additional roadside displays showing the status of next traffic lights ahead and the distance to the next traffic light so the driver can adjust their driving speed accordingly. The additional display can be placed right after or close to the prior traffic light if the distance between two traffic lights is short (e.g. the distance allow a car to reach the next traffic light within a full cycle of traffic light switch, which equals to total duration time of green light+red light+yellow light). Or it can be installed in the middle between the traffic lights and the next traffic lights ahead. The status of next traffic lights can include the current light status, how long it will remain and how long other light will last, it can also include suggested driving speed to catch the green light. It can provide visual display and optionally send those data in wireless signal to the car/dashboard device/cellphone app so that they generate driving guidance such as recommended speed to the driver. FIG. 11 shows two examples of the system placed close to the first to the traffic lights or in the middle of two intersections.

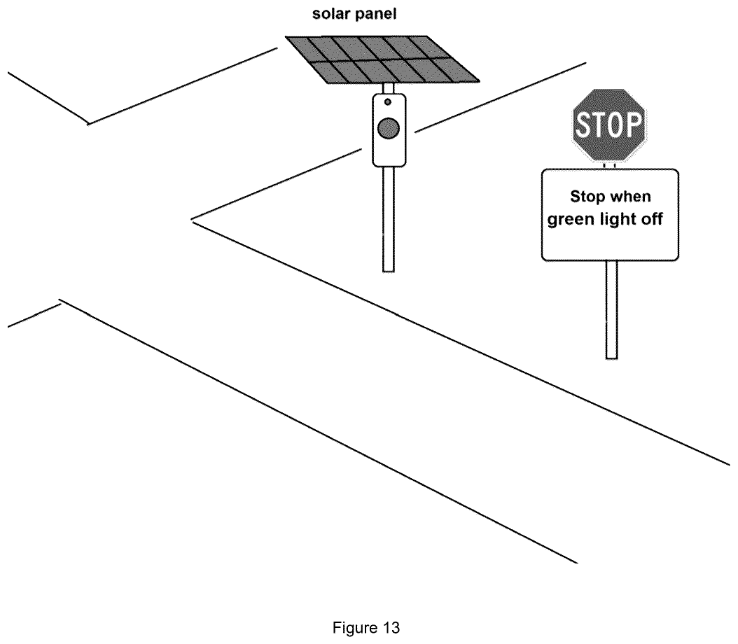

The current invention also discloses an intelligent stop sign system. In some embodiments, it is solar powered. It has a green light (and optionally additional red light) or a display to instruct the driver to stop or pass. In some embodiments, it has a camera, which can monitor how many cars are coming/waiting within a preset distance at the direction it monitors, therefore the circuitry/control unit of the system will decide the status (on/off) of the light/display accordingly. The system can communicate with other system installed for the same intersection using wire or wireless signal to synchronize the signal. Examples are shown in FIGS. 12 and 13.

When only two signs are installed, the cameras face to and monitor the traffic perpendicular to streets the sign installed. The camera can be installed outside the main body of the system for better view. If no car is coming within the preset distance (e.g. 100 or 200 feet), the green light is on or display shows no stop required instruction (e.g. “Go”). Otherwise the red light will be on or the display shows stop required instruction (e.g. “Stop sign effective”), or no display/light off so the classical stop sign rule is enforced. As shown in FIG. 12, the system is powered by solar panel. The system has painted instruction board/panel on how to read/use the system. FIG. 12 left shows a system has a red light and a green light and also a standard printed stop sign. When the camera detect no car within the preset distance in the perpendicular street, the green light will be on to allow the car to pass without stopping. When the camera detect car within the preset distance in the perpendicular street, the red light is on and the car facing the stop sign need to prepare to stop. If both green light and red light are off (e.g. no power or system failure), the printed top sign will be effective as in indicated on the printed instruction panel.

When four signs are installed for all the directions in the intersection, the cameras can face to and monitor the traffic of the same direction of the light/display for. If no car or less car are coming within the preset distance (e.g. 100 feet) at the perpendicular direction, the green light is on or display shows no stop required instruction (e.g. “Go”). Otherwise the red light will be on or the display shows stop required instruction (e.g. “Stop sign effective”), or no display/light off so the classical stop sign rule is be enforced. As shown in FIG. 12 right, a red STOP is printed on the panel below the LED display, when no car are detected by the camara on other stop signs at perpendicular direction, the LED display will show “Go, no stop” in green. The car can pass the stop sign without waiting. When the stop sign at perpendicular direction sees cars, the LED will be off and the printed stop sign will be effective.

As shown in FIG. 13, the solar panel powered light or LED display can be placed separated from the printed stop sign/instruction board/panel and work together. Alternatively, solar panel powered light/LED display with instruction board/panel can be used together with standard stop sign.

In current invention, speed limit means either the speed limit set by the road agency or the highest speed that user can drive safely on the road acceptable by public based on common sense if there is no issued speed limit from agency. The driver means either the human driving the car or the autopilot of the car. The roadside sign, roadside display and roadside sign/display can be used interchangeable, which means a structure placed on the roadside having either a static sign or display, or a dynamic display, or their combination. In the current application, the “/” mark means “and” and/or “or” and/or their combination. Unless otherwise defined, all technical and scientific terms used herein have the same meaning as commonly understood by one of ordinary skill in the art to which this invention belongs. All patents and publications mentioned in this specification are indicative of the level of those skilled in the art to which the invention pertains. All patents and publications are herein incorporated by reference to the same extent as if each individual publication was specifically and individually indicated to be incorporated by reference. The inventions described above involve many well-known knowledge, instruments, methods and skills. A skilled person can easily find the knowledge from text books, scientific journal papers and other well-known reference sources.

1. A driving aid system for improving safety and energy efficiency of a vehicle, said system comprising:
a traffic lights having a wireless signal transmitter that transmits its traffic light status data; and
a roadside sign having a wireless signal receiver, wherein the roadside sign is placed away from the traffic lights, receives traffic light status data from the traffic lights ahead and informs the vehicle passing said roadside sign if the vehicle can pass the traffic lights without stopping.

2. The system of claim 1, wherein the traffic light status data includes the time left before the traffic lights turns to red light.

3. The system of claim 1, wherein the roadside sign is at least 0.1 miles away from the traffic lights.

4. The system of claim 1, wherein the roadside sign has a LED display.

5. The system of claim 1, wherein the roadside sign is solar powered.

6. A method for improving safety and energy efficiency of a vehicle, the method comprising:
a traffic lights transmits its traffic light status data to a roadside sign placed away from the traffic lights;
the roadside sign receives the traffic light status data from the traffic lights ahead to compare the time left before the traffic lights becomes red and the minimum time required to reach the traffic lights from the roadside sign at safe speed; and
the roadside sign informs the vehicle passing it that the vehicle needs to prepare to stop at the traffic lights ahead if the time left is less than the minimum time required.

7. The method of claim 6, wherein the traffic lights has a wireless signal transmitter to transmit its traffic light status data.

8. The method of claim 6, wherein the roadside sign has a wireless signal receiver to receive the traffic light status data.

9. The method of claim 6, wherein the roadside sign uses LED display to inform the vehicle.
